(19) United States
(12) Patent Application Publication
(10) Pub. No.: US 2024/0367185 A1
(43) Pub. Date: Nov. 7, 2024

(54) AIRLESS FLUID SPRAYING SYSTEM WITH FLUID FILTER DIAGNOSTICS

(71) Applicant: Wagner Spray Tech Corporation, Plymouth, MN (US)

(72) Inventors: Brian Lee FIDELER, Jordan, MN (US); Joseph W. KIEFFER, Chanhassen, MN (US); Christopher Daniel NOTO, Carver, MN (US)

(21) Appl. No.: 18/651,800

(22) Filed: May 1, 2024

Related U.S. Application Data
(60) Provisional application No. 63/499,776, filed on May 3, 2023.

(51) Int. Cl. B05B 9/01; B05B 15/40

(52) U.S. Cl. CPC B05B 9/01; B05B 15/40

(57) ABSTRACT

An airless paint spraying system includes a spray tip, a paint pump configured to pump paint from a paint source, and a motor configured to drive the paint pump to pressurize the paint along a flow path to the spray tip. The spray tip releases the paint in an atomized spray pattern. A paint filter is configured to filter the paint. The airless paint spraying system includes a filter diagnostic system configured to receive an indication of an operational characteristic representing operation of the paint spraying system, generate a filter status based on the operational characteristic, and generate an output representing the filter status.

### CROSS-REFERENCE TO RELATED APPLICATION

The present application is based on and claims the benefit of U.S. provisional patent application Ser. No. 63/499,776, filed May 3, 2023, the contents of which are hereby incorporated by reference in their entirety.

### BACKGROUND

In a typical airless fluid spraying system, a pump receives and pressurizes a fluid (such as paint), delivers the pressurized fluid to an applicator (such as a spray gun), which, in turn, applies the pressurized fluid to a surface using a spray tip having a geometry selected to emit a desired spray pattern (e.g., a round pattern, a flat pattern, or a fan pattern, etc.). Fluid spraying systems also typically includes one or more filters that filter out unwanted contaminants in the fluid. The filter(s) can be located at various locations along the flow path from the fluid source to the spray outlet.

The discussion above is merely provided for general background information and is not intended to be used as an aid in determining the scope of the claimed subject matter. The claimed subject matter is not limited to implementations that solve any or all disadvantages noted in the background.

### SUMMARY

An airless paint spraying system includes a spray tip, a paint pump configured to pump paint from a paint source, and a motor configured to drive the paint pump to pressurize the paint along a flow path to the spray tip. The spray tip releases the paint in an atomized spray pattern. A paint filter is configured to filter the paint. The airless paint spraying system includes a filter diagnostic system configured to receive an indication of an operational characteristic representing operation of the paint spraying system, generate a filter status based on the operational characteristic, and generate an output representing the filter status.

These and various other features and advantages will be apparent from a reading of the following Detailed Description. This Summary and Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view showing one example of an airless paint spraying system.

FIG. 2 is a block diagram showing an example paint spraying environment.

FIG. 3 illustrates an example of pressure sensors for detecting pressure drop across a paint filter.

FIG. 4 is a flow diagram illustrating an example operation for generating a filter status.

FIG. 5 is a diagram showing an example user interface display.

FIGS. 6A-6D illustrate example user interface displays.

FIG. 7 shows one example of the architecture illustrated in FIG. 2, deployed in a remote server environment.

FIGS. 8-10 show examples of mobile devices that can be used as operator interface mechanisms in the architectures shown in the previous Figures.

FIG. 11 is a block diagram showing one example of a computing environment that can be used in the architectures shown in the previous Figures.

While the above-identified figures set forth one or more examples of the disclosed subject matter, other examples are also contemplated, as noted in the disclosure. In all cases, this disclosure presents the disclosed subject matter by way of representation and not limitation. It should be understood that numerous other modifications and examples can be devised by those skilled in the art which fall within the scope and spirit of the principles of this disclosure.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

While some examples are described herein in the context of applying paint to a surface, it is understood that the concepts are not limited to these particular applications. Other applications include applying other types of fluids, such as, but not limited to, foams, textured materials, plural components, adhesive components, food products, to name a few.

As used herein, examples of “paint” includes substances composed of coloring matter, or pigments, suspended in a liquid medium as well as substances that are free of coloring matter or pigment. Paint can include preparatory coatings, such as primers. Further, paint can be applied to coat a surface as a liquid or a gaseous suspension, for example, and the coating provided can be opaque, transparent, or semi-transparent. Some particular examples include, but are not limited to, latex paint, oil-based paint, stain, lacquers, varnish, inks, and the like.

Further, while some examples are discussed herein in the context of “airless” systems, it is expressly contemplated that the present features can also be utilized with other types of fluid application systems. For example, the present features can be utilized with air driven or air pressurized sprayers, that utilize an air compressor, air turbine, or other air source that generates air flow to spray the fluid.

Further yet, while some examples are discussed herein in the context of spraying systems that spray the fluid onto the target surface, it is expressly contemplated that the present features can also be utilized with systems that apply the fluid in other ways, such as through a roller, a brush, a pad, etc.

In an example airless painting system, a pump receives and pumps paint to an applicator (such as a spray gun, roller, etc.), which applies the paint to a surface. For example, an airless paint spraying system can pump pressurized paint using a positive displacement pump (e.g., a piston pump), or other type of pumping system, to a pressure (e.g., above one thousand pounds per square inch (PSI) that results in atomization of the paint from a spray tip having a geometry configured to emit a desired spray pattern (e.g., a round pattern, a flat pattern, or a fan pattern, etc.).

In some example painting systems, a filter (reusable or disposable) is disposed along the paint path to remove debris from the paint. An example filter includes a filter medium supported by a filter support having outlet opening(s) for the path flow path and which surrounds the filter medium. The filter medium can be made of any of a variety of filter materials such as, but not limited to, a fabric, a wire mesh, a nylon mesh, etc.

Further, the filter can be disposed near the inlet from the paint source, near the pump (before or after the pump), at or near the application, or at any of a variety of other locations. Over time, the filter becomes clogged which degrades performance of the system by reduced paint flow. It is difficult, if at all possible, for the user to determine the current state of the filter and to determine when the filter needs to be removed for cleaning and/or replacement.

The present disclosure is directed to a filter diagnostics and control system configured to obtain operational characteristics of an airless painting system and to generate a filter status representing a current state of the filter, such as a current or remaining “life” of the filter. The filter life can indicate whether the filter is clogged or otherwise degraded to the point of needing to be removed for cleaning and/or replacement. The filter status can be rendered to the user in any of a number of ways. For example, an indication of the filter status can be displayed on an output device (e.g., display screen, warning light, etc.) of the pump unit and/or on a mobile device of the user. Alternatively, or in addition, an audible alert can be provided to the user when the filter life reaches a threshold, indicating that the filter should be cleaned and/or replaced.

The filter status can be determined in a number of ways. For example, a pressure drop across the filter can be determined using pressure sensors disposed on opposing sides (e.g., upstream and downstream) of the filter. Alternatively, or in addition, a volume of paint pumped through the paint filter and/or an amount of time that the pump has operated can be utilized to generate an indication of a filter status.

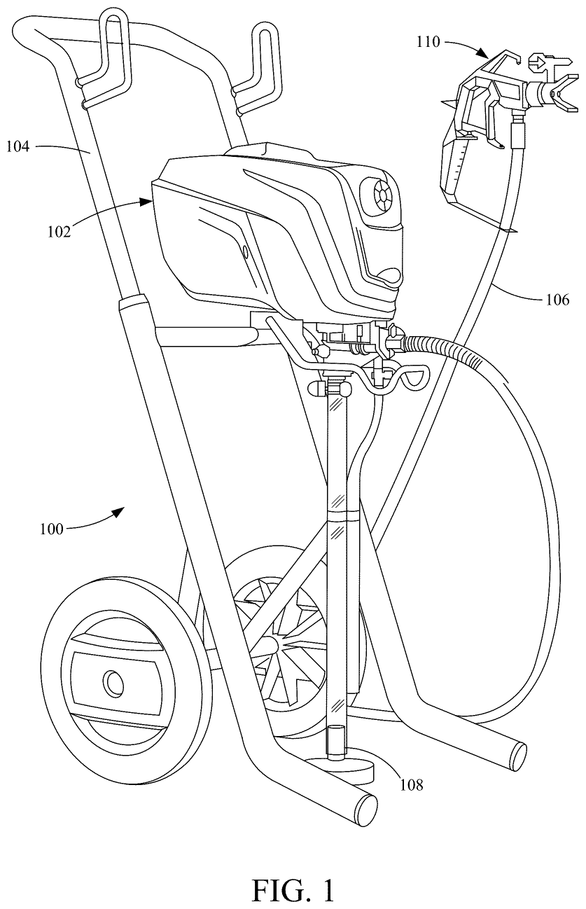

FIG. 1 is a perspective view showing one example of an airless paint spraying system 100. Spraying system 100 includes a pump 102 that is mounted on a cart 104 and couples to an applicator 110 through a delivery line 106. Pump 102 includes a fluid intake 108 that is exposed to a fluid source (e.g., a five-gallon bucket of paint). Pump 102 pumps the fluid from the fluid source through fluid intake 108 and pumps the fluid at a given pressure to applicator 110 (illustratively a spray gun) through delivery line 106.

In some examples, an electronic device (e.g., smart phone, tablet, personal computer (PC), etc.) can interface with the pump through a wired or wireless connection. The electronic device can also provide a user interface for a user to control and/or monitor operations of the spraying system 100, such as setting fluid pressure, entering cleaning mode, tracking fluid throughput, etc. In some examples, water can being pumped through spraying system 100 to clean the system is detected and not counted as fluid throughput.

An internet or other network connection of the electronic device can be used to update the software/firmware of the spraying system 100. In other examples, spraying system 100 can directly connect to the internet or another network.

One or more paint filters are configured to filter the paint prior to being sprayed from applicator 110. A paint filter can be disposed at any of a variety of locations along the paint flow path. For example, a paint filter can be located at or near intake 108. Alternatively, or in addition, a paint filter can be located at or near an inlet or outlet of pump 102. Further yet, a paint filter can be located along delivery line 106 and/or in applicator 110. These filter locations are for sake of example only.

While system 100 is illustrated as a cart-based system, in another example an airless spraying system includes a handheld airless spray gun, such as a “cup gun” or the like. The present filter detection and diagnostic features can be applied to other types of airless system as well.

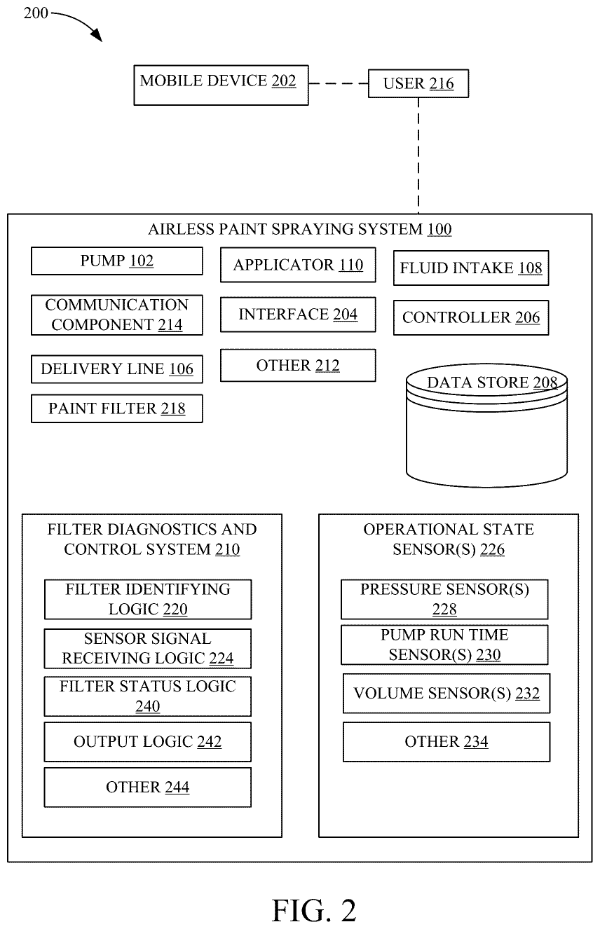

FIG. 2 is a block diagram showing an example paint spraying environment 200. For sake of illustration, but not by limitation, environment 200 will be described in the context of system 100 and similar elements are similarly numbered.

Environment 200 includes airless paint spraying system 100 and a mobile device 202, but can include other items as well. Spraying system 100 includes pump 102 (e.g., a reciprocating piston pump) driven by a motor that pumps paint from a paint source to applicator 110 having a spray tip. System 100 also includes an interface 204, a controller 206, a data store 208, a filter diagnostics and control system 210, and can include other items 212 as well.

Controller 206 can include computer processors with associated memory and timing circuitry, not separately shown, which are functional parts of the systems or devices to which they belong and are activated by, and facilitate the functionality of the other components or items in those systems. For example, controller 206 includes a computing device, such as a microprocessor, that communicatively couples to pump 102 and sends signals to pump 102 to control various aspects of operation of pump 102. For example, controller 206 monitors pump operation and controls the pump to maintain a paint pressure as the paint is pumped to applicator 110. In one example, controller 206 includes integrated software or logic components to perform a variety of different functions. For example, integrated software may be used to change the state of a solenoid in a reciprocating piston pump. Controller 206 couples to communication component 214 that allows communication with mobile device 202.

Data store 208 can store information associated with the pump, tip, spray gun/applicator, users, jobs, etc. For example, as a tip is used, the wear on the tip (e.g., calculated based on throughput of paint, calculating a tip orifice diameter, etc.) can be stored with the tip identifier in data store 101 as tip data 624. As another example, the pump hours can be stored in data store 208. Data store 208 can reside on spraying system 100 or in another environment, such as a remote server.

Interface 204 includes input/output mechanisms and allows a user 216 to control pump 102 and the spray pattern generated by the spraying operation. Interface 204 can be located on a housing of pump 102 or can be located remotely as well. For example, interface 204 could be on another device (such as mobile device 202) that sends control signals to pump 102 wirelessly, or through wired connection. Interface 204 could include different devices and/or mechanisms as well.

Filter diagnostics and control system 210 includes various software or hardware logic components. In some examples, these components are implemented by controller 206. In other examples, these components are implemented by a different controller or processor (e.g., one or more processors located at a remote server).

System 210 includes filter identifying logic 220 configured to identify paint filter 218. For example, filter identifying logic 220 receives sensor signals that indicate the filter model and/or serial number. In one example, filter identifying logic 220 can receive sensor signals from a camera that reads a code on the filter. In another example, sensor signals from a wireless communication sensor that identifies the filter based on a wireless signal (e.g., a radio frequency identification (RFID) signal, a Bluetooth signal, a near field communication (NFC) signal, etc.). In another example, the tip identifier can be received by user input through mobile device 202 and/or interface 204. In this way, a user can manually select the filter installed in system 100.

System 210 also includes sensor signal receiving logic 224 configured to receive sensor signals from one or more operational state sensors 226 configured to detect an operational state of airless paint spraying system 100. For example, sensors 226 can include one or more pressure sensors 228, pump runtime sensors 230, paint volume sensors 232, or other sensors 234.

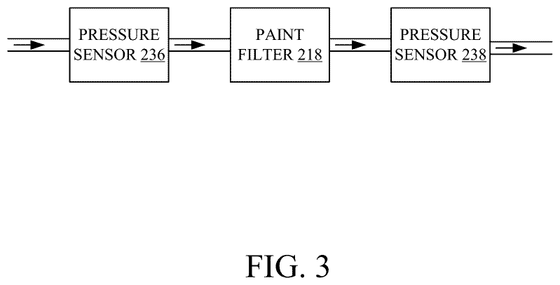

Pressure sensors 228 are configured to detect paint pressure at one or more locations along the flow path. One example is schematically illustrated in FIG. 3.

As shown in FIG. 3, a first pressure sensor 236 is positioned upstream of paint filter 218 and configured to detect a pressure of the paint before passing through paint filter 218. A second pressure sensor 238 is disposed after paint filter 218 and configured to generate an indication of the paint pressure after paint filter 218. The difference between the pressures sensed by pressure sensors 236 and 238 represents a pressure drop across paint filter 218.

Referring again to FIG. 2, pump runtime sensors 230 are configured to generate an indication of a runtime of pump 102, such as in terms of a number of hours that the pump has been run to pump paint through paint filter 218.

Paint volume sensors 232 are configured to generate an indication of a volume of paint that has been pumped through paint filter 218, such as an in terms of a number of total gallons of paint filtered by paint filter 218. In one example, sensor 232 includes a flow meter. In another example, such as where pump 102 is a positive displacement pump, sensor 232 can count or otherwise determine a number of cycles of pump 102, and the number of cycles can be correlated to a volume of paint per cycle, to compute a total volume pumped through paint filter 218.

System 210 includes filter status logic 240, output logic 242, and can include other items 244 as well. Filter status logic 240 is configured to generate a filter status based on the operational characteristics identified by the sensor signals received by logic 224. For example, the filter status generated by logic 240 can indicate a current filter life, such as on a scale of one hundred percent (indicating a new filter) and zero percent (indicating a clogged filter that needs to be replaced). This, of course, is for sake of example only.

Output logic 242 is configured to generate an output representing the filter status, such as by controlling interface 204 to display or otherwise render an indication of the filter status. Alternatively, or in addition, output logic 242 can output the filter status to mobile device 202 to render a user interface on mobile device 202. Examples of user interfaces are described below.

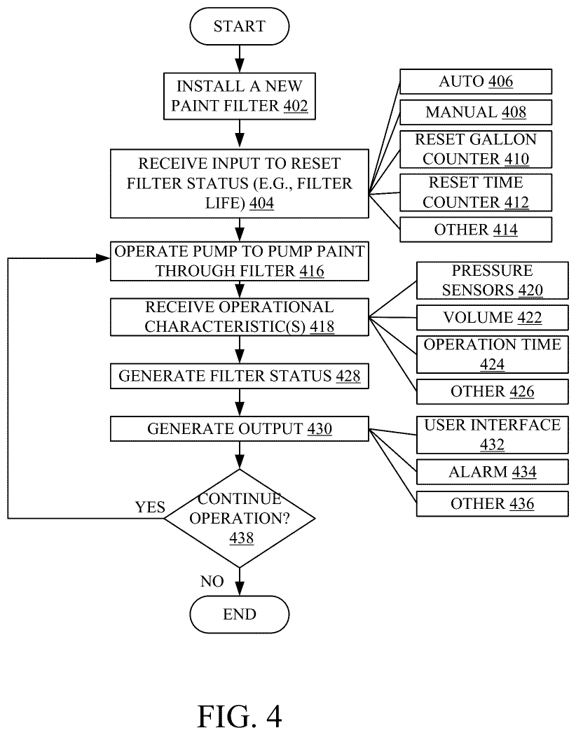

FIG. 4 is a flow diagram 400 illustrating an example operation of an airless paint spraying system. For sake of illustration, but not by limitation, FIG. 4 will be discussed in the context of environment 200 shown in FIG. 2.

At block 402, a new paint filter 218 is installed. At block 404, an input is received to reset a filter status (e.g., a remaining filter life), corresponding to the new filter, tracked by system 210. The input can be automatic, as represented at block 406. For example, the system can be configured to automatically detect when the user installs a new paint filter. Alternatively, or in addition, the input can be manual, at block 408. For example, the user can interact with mobile device 202 and/or interface 204 to provide an input indicating that a new filter has been installed. The input at block 404 can be used to reset a gallon counter at block 410 and/or reset a time counter at block 412. An example gallon counter tracks the number of gallons that have been pumped through the paint filter. An example time counter tracks the amount of time that the pump has been operated to pump paint through the paint filter. Of course, the input can be received and used to reset filter status in other ways as well, as represented at block 414. In one example, the gallon counter and/or time counter can be stored in data store 208.

At block 416, the pump is operated to spray paint for one or more jobs. During operation, one or more operational characteristics are received at block 418. For example, the operational characteristics can include pressure sensor signals received from pressure sensors at block 420. For example, with respect to FIG. 3, a first pressure sensor signal can be received from a pressure sensor upstream of the paint filter and a second pressure sensor signal can be received from a second pressure sensor downstream of the filter. The first and second pressure sensor signals can be utilized to determine a pressure drop across paint filter 218.

Alternatively, or in addition, the operational characteristics can indicate a volume of paint pumped through the paint filter at block 422, an operation time indicating an amount of time that the pump has been operated to pump paint through the paint filter (block 424), and can include other operational characteristics as well, as represented at block 426.

At block 428, a filter status is generated based on the operational characteristic(s) received at block 418. For example, a lookup table can be utilized to correlate the operational characteristics with a predefined filter status.

For sake of illustration, but not by limitation, a filter status of one hundred percent life can be generated when the pressure sensors indicate a pressure drop less than a first threshold (e.g., ten pounds per square inch (PSI)). A pressure drop between the first threshold and a second threshold (e.g., fifty PSI) can be correlated to a second filter life (e.g., eighty percent). Another filter status can indicate that the filter is worn out or clogged when the pressure drop reaches a third threshold (e.g., one hundred PSI). These, of course, are for sake of example only.

Similarly, the filter status can be correlated to a plurality of different thresholds relative to volume pumped through the filter and/or a time that the pump has been operated with the current filter installed.

At block 430, an output is generated representing the filter status. For example, a user interface can be generated that renders and indication of the filter status at block 432. The user interface can be displayed, for example, on interface 204 and/or mobile device 202. Alternatively, or in addition, an alarm can be generated at block 434 to alert the user when the filter status has reached a predefined level (e.g., 40% life, etc.). Of course, the output can be generated in other ways as well, as represented at block 436.

At block 438, if operation is continued at block 416, additional operational characteristics are received to generate and update the user interface to represent changes in the filter status.

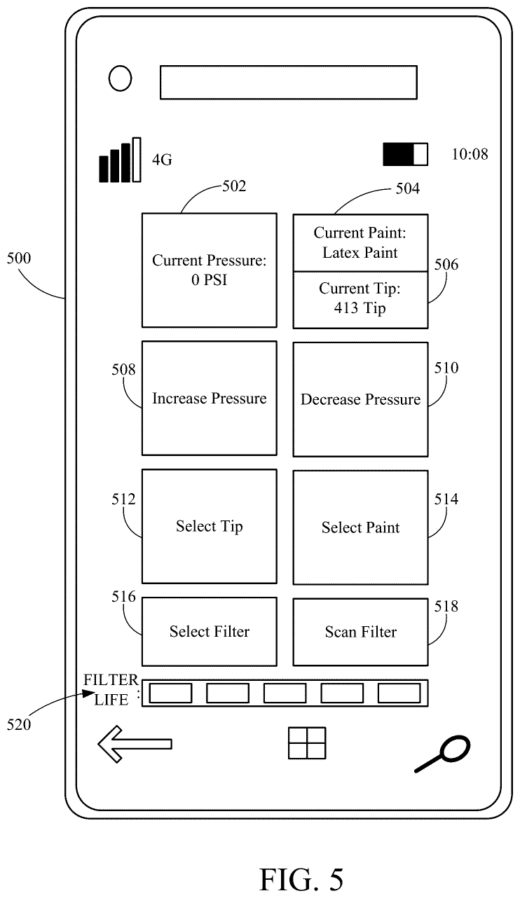

FIG. 5 is a diagram showing an example interface 500. As shown, interface 500 is displayed on a mobile device, such as a smartphone. However, in other examples, interface 500 can be displayed on a different device as well. For example, interface 500 can be located on applicator 110, pump 102, etc.

Interface 500 includes a pressure indicator 502 that displays a current pressure of the fluid being pumped and a fluid indicator 504 that shows the current fluid being pumped. A tip indicator 506 displays a current tip installed in applicator 110 and a pressure increase mechanism 508 is actuatable to increase the current pressure generated by pump 102. Pressure decrease mechanism 510 can be actuated to decrease the current pressure set point.

Tip selection mechanism 512 is actuatable to select the given tip being used and fluid selection mechanism 514 is actuatable to select a fluid that is being applied by applicator 110. A filter selection mechanism 516 is actuatable to select paint filter 218 being used with spraying system 100. For example, the filter selection mechanism 516 is actuatable to display a list of filters from which the user can select the current filter being utilized.

Automatic filter selection mechanism 518 can be actuatable to initiate a detection process, such as by scanning a barcode on the filter or packaging of the filter to detect the particular paint filter 218 being utilized.

Filter life display element 520 displays a current life of the paint filter 218 installed in spraying system 100. Filter life display element 520 illustratively includes a plurality of different filter life ranges that selectively indicate a remaining life of the filter based on the filter status generated based on operational characteristics, such as blocks 418 and 428 discussed above with respect to FIG. 4. In one example, each respective filter life range, of the plurality of different filter life ranges, has a graphical element associated with the respective filter life range. Based on the determined remaining filter life of the paint filter, a particular filter life range of the plurality of different filter life ranges is identified and an output (such as a user interface display) is generated to include the graphical element associated with the particular filter life range.

In one example, a visual representation includes a gauge display element. The gauge display element defines a graphical volume and includes a fill element that visually fills at least a portion of the graphical volume to indicate the remaining filter life of the paint filter.

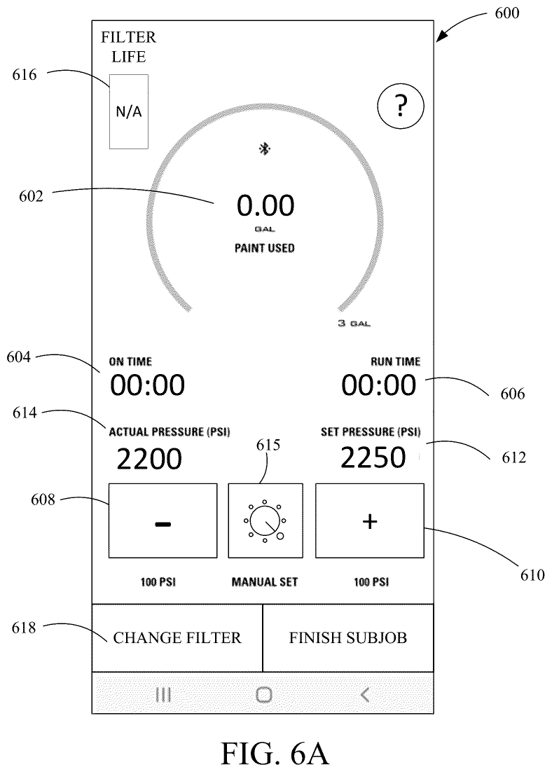

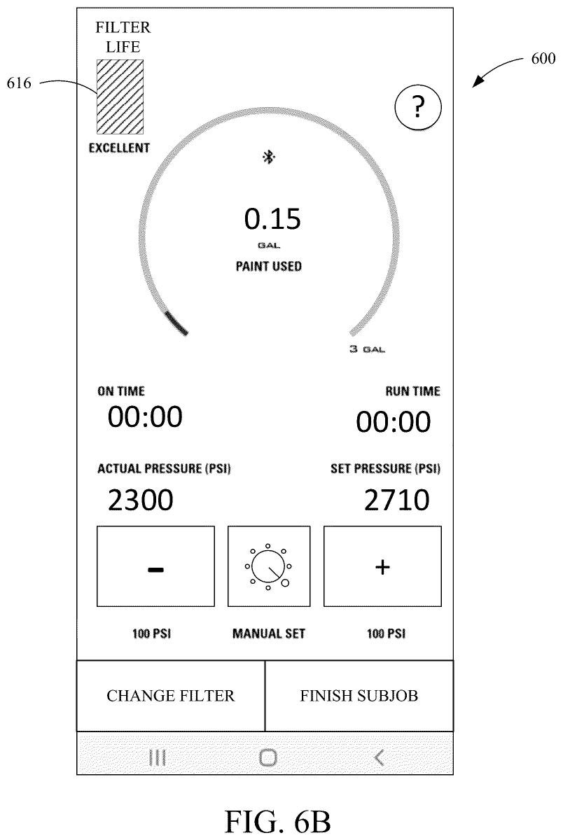

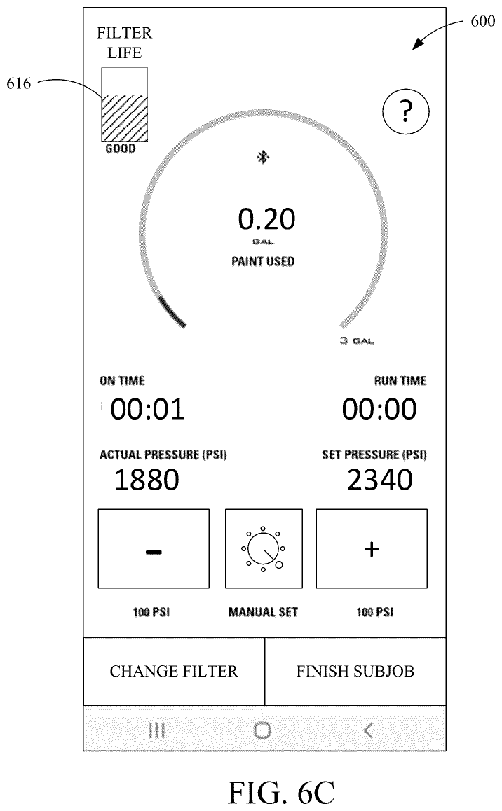

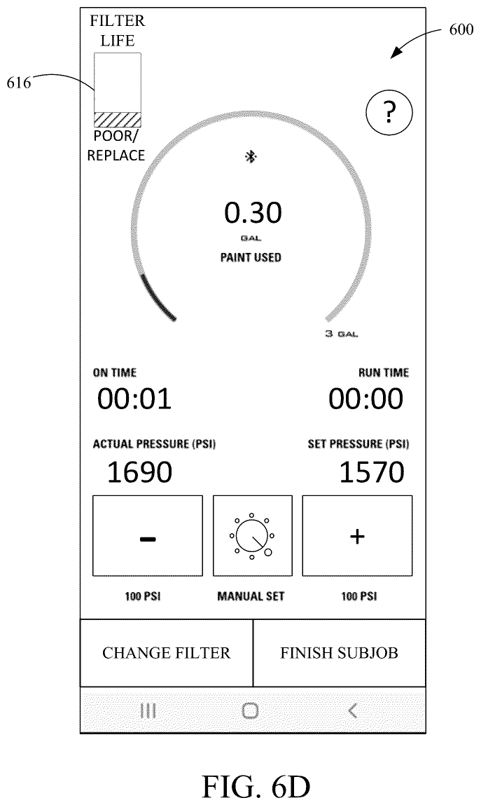

FIGS. 6A-6D illustrate example user interfaces that can be displayed on a display device, such as, but not limited to, mobile device 202 and/or spraying system 100.

FIG. 6A shows an example user interface display 600 having a display element 602 that displays a current amount of paint that has been used, for example based on one or more of pressure, orifice size, pump speed, pump displacement, etc.

User interface display 600 also includes an on-time display element 604 that displays a representation of the amount of time that the system has been powered on and a runtime display element 606 that displays a representation of a runtime of the pump. User interface display 600 also includes pressure controls 608 and 610 that are actuatable, respectively, to decrease or increase the set pressure, which is displayed at pressure set point display element 612. An actual pressure display element 614 displays the actual pressure sensed in the system. A manual pressure set point control 615 can be actuated to display an interface that allows the user to enter the desired pressure set point, rather than using incremental adjustments.

A filter status display element 616 displays the current filter status generated based on the operational characteristics of the system. A change filter control 618 is actuatable to reset the filter status, for example when the user changes the filter.

As shown in FIGS. 6B, 6C, and 6D, the filter status display element 616 changes to indicate the remaining filter life. For example, a series of discrete statuses (illustratively one or more of not available (N/A), excellent, good, and poor or worn out) are displayed when the filter status indicates a filter life in one of a plurality of different ranges. For example, but not by limitation, when the filter life is determined to be between one hundred percent and eighty percent an “excellent” filter life status is displayed by display element 616. When the filter life is between eighty percent and forty percent a “good” filter life can be displayed, and when the filter life is below forty percent a “poor” or “worn out” status is displayed. This, of course, is for example only.

It should also be noted that the different examples described herein can be combined in different ways. That is, parts of one or more examples can be combined with parts of one or more other examples. All of this is contemplated herein.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

As used herein, if a description includes “one or more of” or “at least one of” followed by a list of example features with a conjunction “or” between the penultimate example feature and the last example feature, then this is to be read such that (1) one exemplary embodiment includes at least one of or one or more of each feature of the listed features, (2) another exemplary embodiment includes at least one of or one or more of only one feature of the listed features, and (3) another exemplary embodiment includes some combination of the listed features that is less than all of the features and more than one of the features.

As used herein, if a description includes “one or more of” or “at least one of” followed by a list of example features with a conjunction “and” between the penultimate example feature and the last example feature, then this is to be read such that the exemplary embodiment includes at least one of or one or more of each feature of all the listed features.

As used herein, if a description includes “one or more of” or “at least one of” followed by a list of example features with a conjunction “and/or” between the penultimate example feature and the least example feature, then this is to be read such that, in one example, the description includes “one or more of” or “at least one of” followed by a list of example features with a conjunction “or” between the penultimate example feature and the last example feature, and, in another example, the description includes “one or more of” or “at least one of” followed by a list of example features with a conjunction “and” between the penultimate example feature and the last example feature.

The present discussion has mentioned processors and servers. In one embodiment, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

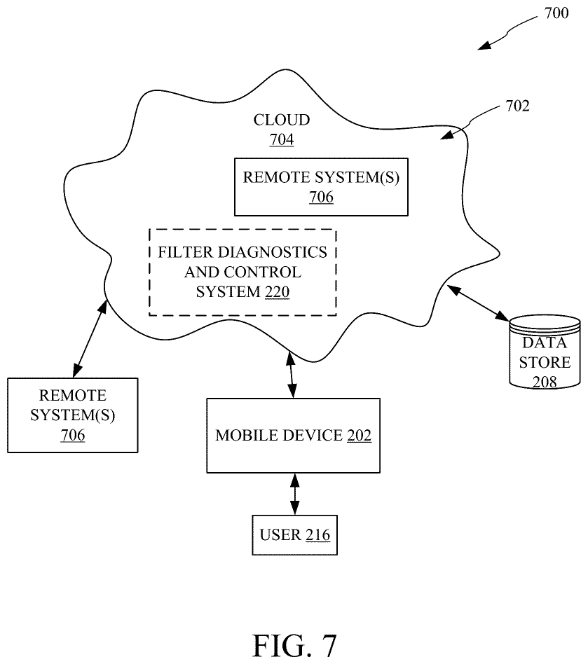

FIG. 7 is a block diagram of environment 200, shown in FIG. 2, deployed in a remote server architecture 700. In an example, remote server architecture 700 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in FIG. 2 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 7, some items are similar to those shown in FIG. 2 and they are similarly numbered. FIG. 2 specifically shows that spray system diagnostics and control system 210 can be located at a cloud 704. Alternatively, or in addition, one or more of remote systems 706 and/or data store 208 can be located at the remote server location 702. Therefore, mobile device 202, user 216, spraying system 100, and other components access those systems through the remote server location.

FIG. 7 also depicts another example of a remote server architecture. FIG. 7 shows that it is also contemplated that some elements of FIG. 2 are disposed at the remote server location while others are not. By way of example, filter diagnostics and control system 210 can be disposed at a location separate from location 702 and accessed through the remote server at location 702. Further, one or more of data stores 208 can be disposed at a location separate from location 1209 and accessed through the cloud 704. Regardless of where they are located, they can be accessed directly by spraying system 100, through a network (either a wide area network or a local area network), they can be hosted at a remote site by a service, or they can be provided as a service, or accessed by a connection service that resides in a remote location.

It will also be noted that the elements of FIG. 2 or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

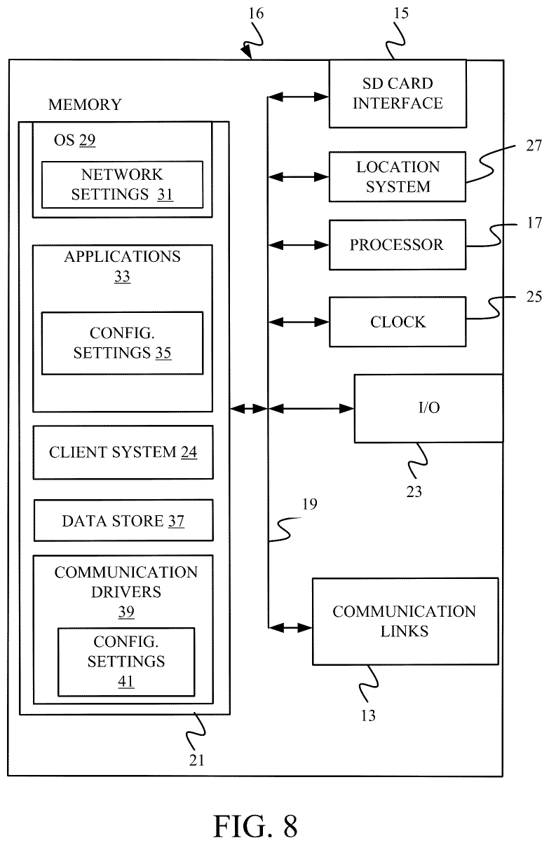

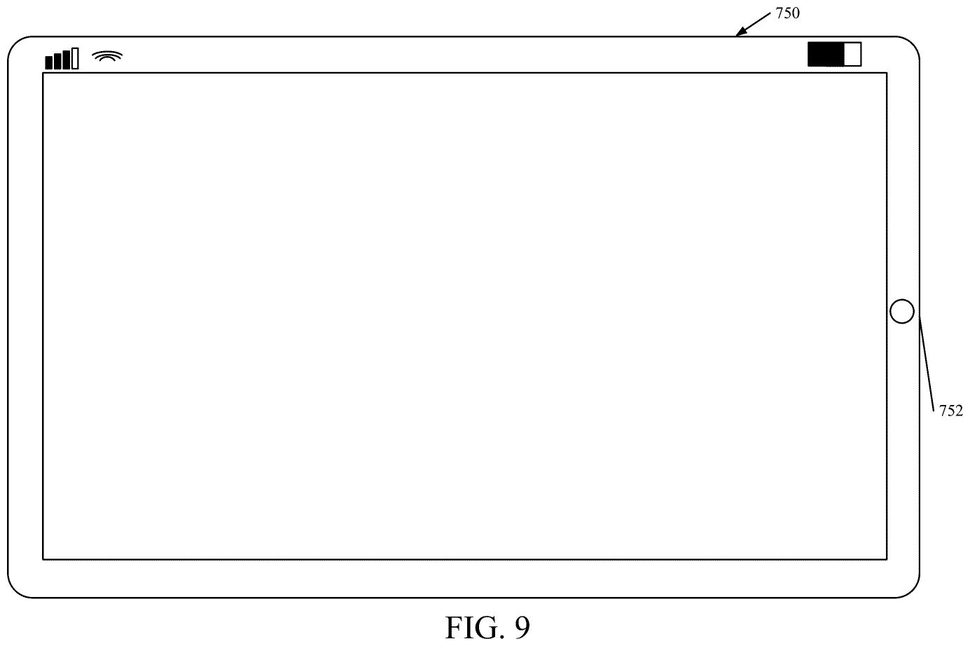

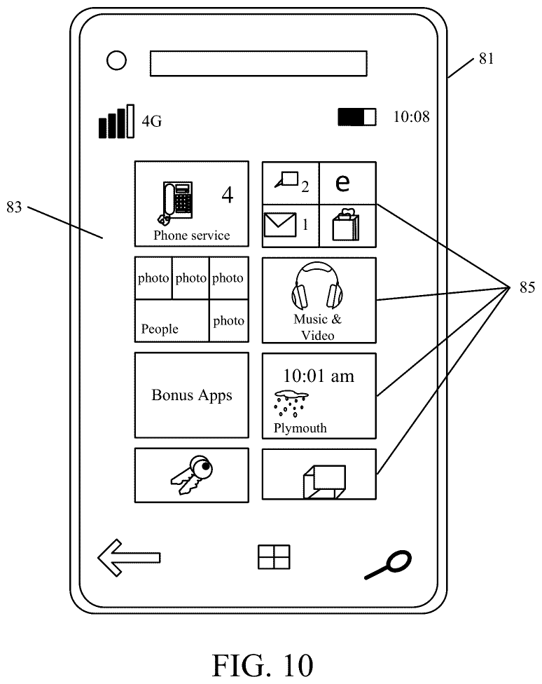

FIG. 8 is a simplified block diagram of one illustrative example of a handheld or mobile computing device that can be used as a user or client device 16, in which the present system (or parts of it) can be deployed. FIGS. 9-10 are examples of handheld or mobile devices.

FIG. 8 provides a general block diagram of the components of a device 16 that can run some components shown in FIG. 2, that interacts with them, or both. In the device 16, a communications link 13 is provided that allows the handheld device to communicate with other computing devices and under some embodiments provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communications link 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various embodiments of the device 16 can include input components such as buttons, touch sensors, optical sensors, microphones, touch screens, proximity sensors, accelerometers, orientation sensors and output components such as a display device, a speaker, and or a printer port. Other types of I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 9 shows one example in which device 16 is a tablet computer 750. In FIG. 9, computer 750 is shown with user interface display screen 752. Screen 752 can be a touch screen or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 750 can also illustratively receive voice inputs as well.

FIG. 10 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. Note that other forms of device 16 are possible.

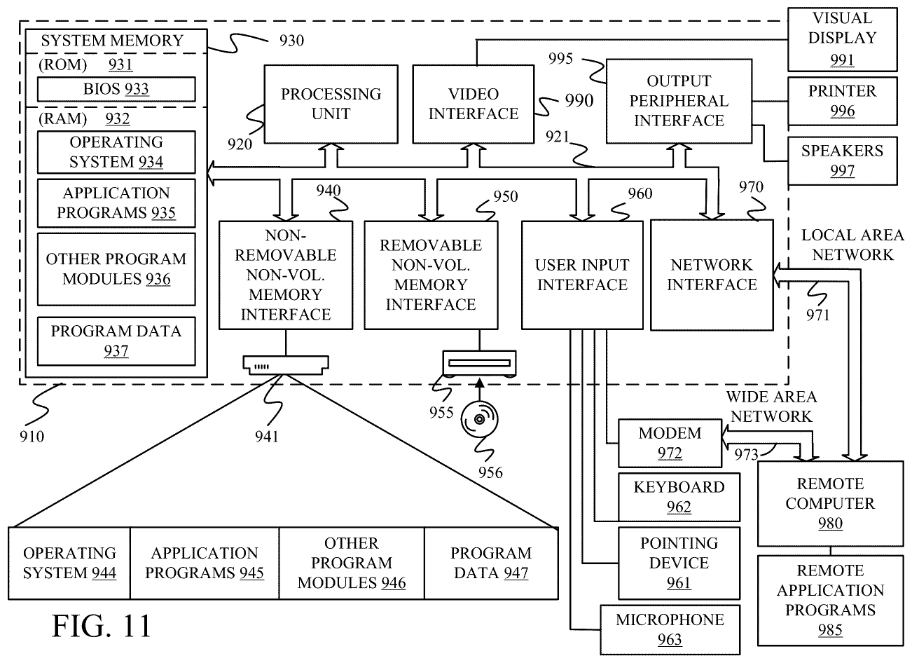

FIG. 11 is one example of a computing environment in which elements of FIG. 2, or parts of it, (for example) can be deployed. With reference to FIG. 11, an example system for implementing some embodiments includes a computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to FIG. 2 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 is typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a local area network-LAN, or wide area network-WAN or a controller area network-CAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 8 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts mentioned above are disclosed as example forms of implementing the claims.

What is claimed is:

1. An airless paint spraying system comprising:
a spray tip;
a paint pump configured to pump paint from a paint source;
a motor configured to drive the paint pump to pressurize the paint along a flow path to the spray tip, wherein the spray tip releases the paint in an atomized spray pattern;
a paint filter configured to filter the paint; and
a filter diagnostic system configured to:
receive an indication of an operational characteristic representing operation of the airless paint spraying system;
generate a filter status based on the operational characteristic; and
generate an output representing the filter status.

2. The airless paint spraying system of claim 1, wherein the airless paint spraying system comprises:
a spray gun having the spray tip; and
a hose forming at least a portion of the flow path from the paint pump to the spray gun, wherein the motor is configured to drive the paint pump to pressurize the paint at a pressure above one thousand pounds per square inch (PSI).

3. The airless paint spraying system of claim 1, wherein the filter diagnostic system is configured to control a display device to display an indication of the filter status.

4. The airless paint spraying system of claim 1, wherein the filter diagnostic system is configured to wirelessly transmit the output to a mobile device.

5. The airless paint spraying system of claim 1, wherein the operational characteristic comprises a pressure drop across the paint filter.

6. The airless paint spraying system of claim 1, wherein the operational characteristic comprises an operation time of the paint pump.

7. The airless paint spraying system of claim 1, wherein the operational characteristic comprises a volume of paint pumped through the paint filter.

8. The airless paint spraying system of claim 1, wherein the output comprises a visual representation of the filter status.

9. The airless paint spraying system of claim 8, wherein the filter status comprises a remaining filter life of the paint filter.

10. The airless paint spraying system of claim 9, wherein the filter diagnostic system is configured to:
compare the remaining filter life to a threshold, and
based on the comparison, generate the visual representation as an alert to change the paint filter.

11. The airless paint spraying system of claim 9, wherein the visual representation comprises a gauge display element, the gauge display element defining a graphical volume and including a fill element that visually fills at least a portion of the graphical volume to indicate the remaining filter life of the paint filter.

12. The airless paint spraying system of claim 9, wherein the filter diagnostic system is configured to:
define a plurality of filter life ranges, each respective filter life range, of the plurality of filter life ranges, having a graphical element associated with the respective filter life range;
determine that the remaining filter life of the paint filter is within a particular filter life range of the plurality of filter life ranges; and
generate the output to include the graphical element associated with the particular filter life range.

13. A method of operating a paint spraying system, the method comprising:
operating a paint pump to pressurize paint along a flow path to a spray tip, wherein the paint spraying system includes a paint filter configured to filter the paint, and the spray tip releases the paint in an atomized spray pattern;
receiving an operational characteristic representing operation of the paint spraying system;
generating a filter status based on the operational characteristic; and
generating a user interface display including a visual representation of the filter status.

14. The method of claim 13, wherein the user interface display is displayed on a mobile device.

15. The method of claim 13, wherein the visual representation comprises an alert to change the paint filter.

16. The method of claim 13, wherein the visual representation represents a remaining filter life of the paint filter.

17. The method of claim 13, wherein the operational characteristic comprises at least one of:
a pressure drop across the paint filter,
an operation time of the paint pump, and
a volume of paint pumped through the paint filter

18. A control system for a paint spraying system having a paint filter, the control system comprising:
at least one processor; and
memory storing instructions executable by the at least one processor, wherein the instructions, when executed, cause the control system to:
operate a paint pump to pressurize paint along a flow path to a spray tip, wherein the spray tip releases the paint in an atomized spray pattern;
receive an operational characteristic representing operation of the paint spraying system;
generate a filter status based on the operational characteristic; and
generate output representation of the filter status.

19. The control system of claim 18, wherein the operational characteristic comprises at least one of:
a pressure drop across the paint filter,
an operation time of the paint pump, and
a volume of paint pumped through the paint filter.

20. The control system of claim 18, wherein the output representation is wirelessly transmitted to a mobile device.
